(19) United States
(12) Patent Application Publication
(10) Pub. No.: US 2025/0013762 A1
(43) Pub. Date: Jan. 9, 2025

(54) ORGANIZATION BASED INFORMATION MANAGEMENT METHODS AND SYSTEMS

(71) Applicant: Innoteck Pty Ltd., Thornlie WA (AU)

(72) Inventor: Ernest WANG, Thornlie WA (AU)

(73) Assignee: Innotek Pty Ltd., Thornlie WA (AU)

(21) Appl. No.: 18/713,684

(22) PCT Filed: Nov. 25, 2022
(86) PCT No.: PCT/AU2022/051420

§ 371 Date: May 27, 2024

(30) Foreign Application Priority Data
Nov. 25, 2021 (AU) 2021903813

(51) Int. Cl. G06F 21/60

(52) U.S. Cl. CPC G06F 21/604; G06F 2221/2113; G06F 2221/2141; G06F 2221/2145

(57) ABSTRACT

An information management method comprising: selectively retrieving data items, in connection with data objects each associated with one or more data items; wherein said selectively retrieving comprises selectively retrieving data items, associated with a selected data object, based on access settings associated with different groups of the data items associated with the data object, when the data object is associated with more than one group of data items.

### FIELD OF THE INVENTION

The present invention relates to methods and systems for information management.

### BACKGROUND

Sending information within and outside an organisation is commonly achieved using emails.

When emails are sent information may be enclosed by way of attached files. An email may include one or more hyperlinks as a reference to an online storage location. An email could also refer to a file by filename with reference to a particular drive and folder location.

In a local area network filesystem, files can generally only be opened by a single user at a time. Online collaboration systems such as Google Drive and Microsoft OneDrive allow concurrent editing of word processing documents, spreadsheets and slideshow presentations. Unless public access is provided, access to such documents generally requires identity authentication, such as with a username and a password.

Local area network filesystems are known to suffer from a number of disadvantages including: being difficult to navigate, having complicated access rights, allowing files to be accidentally deleted, having poor structural style consistency and being difficult to connect to data stores. Online collaboration systems generally suffer from similar disadvantages but with better version control.

There is a need for a system and method for better organising for display, sharing of and collaboration on creating/modifying information. This is particularly so when the extent of sharing and collaboration on creating/modifying information is between different organisations, and even intra-organisation where different types of information have different rights are required to access or share or collaborate on creating/modifying the information.

The present invention seeks to overcome, or at least substantially ameliorate, the disadvantages and/or shortcomings of the background art. Alternatively, the present invention seeks to provide a useful choice/alternative.

In this specification the terms “comprising” or “comprises” are used inclusively and not exclusively or exhaustively.

Any references to documents that are made in this specification are not intended to be an admission that the information contained in those documents form part of the common general knowledge known to a person skilled in the field of the invention, unless explicitly stated as such.

### SUMMARY OF THE INVENTION

According to an aspect of the invention, there is provided an information management method comprising:
selectively retrieving data items, in connection with data objects each associated with one or more data items; wherein said selectively retrieving comprises selectively retrieving data items, associated with a selected data object, based on access settings associated with different groups of the data items associated with the data object, when the data object is associated with more than one group of data items.

In one embodiment each of the data items is associated with an input field and/or a display field.

In one embodiment the data items are, contain or are associated with data content.

In one embodiment the data items include data items each associated with static content.

In one embodiment each of the data objects is associated with a layout for visual display. In one embodiment the data items are each associated with widgets having fields.

In one embodiment the data items include data items each associated with a functional component and a display component. In one embodiment the data items include data items each associated with a functional component, a display component and data content.

In one embodiment the data items include data items associated with at least one input field, each input field for receiving a data value inputted by a user.

In one embodiment the data items include data items associated with at least one display field, each display field for displaying a data value.

In one embodiment the data items include trigger data items, each configured to execute an action in response to an update of a data item, associated with a data object that is associated with the trigger data item. In one embodiment the trigger data items include trigger data items configured to execute actions sharing data objects with different organisations. In an embodiment the update is itself the trigger. In an embodiment the updated data item is compared to a trigger condition (such as a value), which if met results in the triggering of the execution of the action.

In one embodiment a trigger data item is configured to execute a notification action. In one embodiment a trigger data item is configured to execute a share access action.

In one embodiment the data items include chat box data items configured to allow users to communicate and for messages to be displayed sequentially in a chat area.

In one embodiment the data items include sampler data items each configured to provide a display field type for showing data associated with one or more related data objects. In one embodiment the one or more related data objects are related by being grouped for visual display. In one embodiment the visual display comprises a visual stacking of data objects. In one embodiment the one or more data objects are related by being located in a folder.

In one embodiment the method includes updating data items and keeping a historical version of each data item.

In one embodiment each data object is associated with a product inventory.

In one embodiment each data object is associated with a product or service order.

In one embodiment each data object is associated with a product order and delivery process.

In one embodiment each data object is associated with a real world item. In one embodiment each data object is associated with a stock item.

In one embodiment the access settings include organisational structure settings based on an organisation having levels, groups within levels, and child groups restricted to a single parent group in an immediately preceding level.

In one embodiment the organisational structure settings include a self and ancestor groups setting.

In one embodiment the organisational structure settings include a self, sibling and ancestor groups setting.

In one embodiment the organisational structure settings include a self and sibling groups setting.

In one embodiment the organisational structure settings include an ancestor groups setting.

In one embodiment the organisational structure settings include each of: (i) a self and ancestor groups setting; a self, siblings and ancestor groups setting; a self and siblings groups setting; and an ancestors groups setting.

In one embodiment the organisational structure settings include a sibling groups setting.

In one embodiment the organisational structure settings include an ancestor groups setting.

In one embodiment the organisational structure settings include a child groups setting.

In one embodiment the organisational structure settings include a parent group setting.

In one embodiment the access settings include a selector for directly selecting users and groups irrespective of relationships between groups.

In one embodiment the access settings include an editable setting type; a view-only setting type; and a restricted setting type.

In one embodiment the access settings include an editable setting type, a view only setting type and an obscured setting type.

In one embodiment the access settings include an editable setting type, a view only setting type and a hidden setting type.

In one embodiment the access settings include an editable setting type, a view only setting type, an obscured setting type and a hidden setting type.

In one embodiment the data items include data items selected from a visual grouping of data item types.

In one embodiment the data item types include a chat-box item type.

In one embodiment each data item is associated with a functional element type selected from a grouping of functional element types. In one embodiment the method includes selecting different data item types using the grouping of functional element types.

In one embodiment the method includes selectively retrieving data items, associated with a selected data object, based on access settings applied to each data item independently, when the data object is associated with more than one group of data items.

In one embodiment the method includes selectively retrieving data items, associated with a selected data object, based on access settings independently associated with different groups of the data items associated with the data object, when the data object is associated with more than one group of data items.

In one embodiment the method includes selectively retrieving data items, associated with a selected data object, based on access settings including inter-organisation access settings and intra-organisation access settings.

In one embodiment the method includes providing a number of link settings selectively associating the data items of different data objects. In one embodiment the link settings are based on inter-organisation access settings and/or intra-organisation access settings.

In one embodiment the link settings define update rules between associated data items of the different data objects.

In one embodiment the method includes sending a data object from one user to another. In one embodiment the other user has a respective other device selectively retrieve data items, in connection with the received data object associated. In one embodiment the other user's device selectively retrieves the data items, associated with the received data object based on access settings associated with a group that the other user is associated with. In one embodiment the group the other user is associated with comprises access settings. In one embodiment the access settings are based on the organisation of the receiver.

According to an aspect of the invention, there is provided an information management system comprising:
a provider for selectively retrieving data items, in connection with data objects each associated with one or more data items; wherein the provider is configured to selectively retrieve data items, associated with a selected data object, based on access settings associated with different groups of the data items associated with the data object, when the data object is associated with more than one group of data items.

According to an aspect of the invention, there is provided an information management method comprising:
associating access settings with data items, in connection with data objects each associated with one or more data items; wherein associating access settings comprises associating access settings with different groups of the data items, associated with a selected data object, in a manner permitting each of the groups of the data items to be associated with a different access setting, when the data object is associated with more than one group of data items.

In one embodiment associating access settings comprises associating access settings based on groups of an organisational structure relative to a group within which a user is positioned.

In one embodiment associating access settings comprises associating access settings based on a self and ancestor groups option.

In one embodiment associating access settings comprises associating access settings based on a self, sibling and ancestor groups option.

In one embodiment associating access settings comprises associating access settings based on a self and sibling groups option.

In one embodiment associating access settings comprises associating access settings based on an ancestor groups option.

In one embodiment associating access settings comprises associating access settings based on the group comprising: (i) a self and ancestor groups option; (ii) a self, sibling and ancestor groups option; (iii) a self and sibling groups option; and (iv) an ancestor groups option.

According to an aspect of the invention, there is provided an information management system comprising:
an associator for associating access settings, in connection with data objects each associated with one or more data items; wherein the associator is configured to associate access settings with different groups of the data items, associated with a selected data object, in a manner permitting each of the groups of the data items to be associated with a different access setting, when the data object is associated with more than one group of data items.

In one embodiment the associator is configured to associate access settings based on groups of an organisational structure relative to a group within which a user is positioned.

In one embodiment the associator is configured to associate access settings based on a self and ancestor groups setting.

In one embodiment the associator is configured to associate access settings based on a self, sibling and ancestor groups option.

In one embodiment the associator is configured to associate access settings based on a self and sibling groups option.

In one embodiment the associator is configured to associate access settings based on an ancestor groups option.

In one embodiment the associator is configured to associate access settings based on the group comprising: (i) a self and ancestor groups option; (ii) a self, sibling and ancestor groups option; (iii) a self and siblings group option; and (iv) an ancestors group option.

According to an aspect of the invention, there is provided an information management method comprising:
providing data items in connection with data objects each associated with one or more data items; said providing comprising providing linked data items; and updating the linked data items in response to linked data item access requests.

In one embodiment the method includes delinking linked data items.

In one embodiment the method includes providing the option of linked data items.

In one embodiment the linking is based on inter-organisation access settings and/or intra-organisation access settings.

In one embodiment when data associated with one of the data items is changed, data associated with the changed data item is replicated to each linked data item.

According to an aspect of the invention, there is provided an information management system comprising:
a provider for providing data items in connection with data objects each associated with one or more data items; wherein the provider is configured to provide linked data items; and update the linked data items in response to linked data item access requests.

In one embodiment the system includes a link associator configured to delink linked data items.

In one embodiment the system includes a selector configured to provide an option of linking data items.

In one embodiment the system includes a selector configured to provide an option of delinking linked data items.

According to an aspect of the invention, there is provided an information management method comprising:
storing groups of identities of users and group relationships, the group relationships defining associations between the groups to define an organisational structure; and
providing a selector configured to allow a user within at least one group of the organisational structure to select another group relative to a group within which the user is positioned.

In one embodiment the at least one group comprises a single group and the selector is configured to allow a user to select another group relative to the group within which the user is positioned.

According to an aspect of the invention, there is provided an information management system comprising:
a storage for storing a store of groups of identities of users and group relationships, the group relationships defining associations between the groups to define an organisational structure; and
a selector configured to allow a user within at least one group of the organisational structure to select another group relative to a group within which the user is positioned.

In one embodiment the at least one group comprises a single group and the selector is configured to allow a user to select another group relative to the group within which the user is positioned.

According to an aspect of the invention, there is provided an information management method comprising:
sampling data items, in connection with data objects each associated with one or more data items; wherein sampling data items comprises sampling data items associated with groups of data objects.

According to an aspect of the invention, there is provided an information management method comprising:
a sampler for sampling data items in connection with data objects each associated with one or more data items; wherein the sampler is configured to sample data items associated with groups of data objects.

According to an aspect of the invention, there is provided an information management system comprising:
a builder for creating data objects having data items, the data items of each data object for visual display;
a customizer configured to allow access settings to be specified for different groups of data items.

According to an aspect of the invention, there is provided an information management method comprising:
creating data objects having data items, the data items of each data object for visual display;
associating different access settings with different groups of data items associated with a selected data object, when the data object is associated with more than one group of data items.

According to an aspect of the invention, there is provided an information management system comprising:
a store of data items each associated with a data object for visual display;
a selector configured to selectively retrieve data items, associated with a selected data object, based on access settings associated with different groups of the data items associated with the data object, when the data object is associated with more than one group of data items.

According to an aspect of the invention, there is provided an information management system comprising:
a builder for defining an organisational structure comprising groups, the builder having an associator for defining group relationships between groups to define the organisational structure.

According to an aspect of the invention, there is provided an information management method comprising:
defining an organisational structure comprising groups, including defining group relationships between the groups to define the organisational structure; and
providing a selector configured to allow a user within at least one group of the organisational structure to select another group relative to a group within which the user is positioned.

In one embodiment the at least one group comprises a single group and the selector is configured to allow a user to select another group relative to the group within which the user is positioned.

According to an aspect of the invention, there is provided an information management method comprising:
storing data items, in connection with data objects each associated with one or more data items; updating the data items; and keeping a historical version of each data item.

According to an aspect of the invention, there is provided an information management system comprising:
a store for storing data items, in connection with data objects each associated with one or more data items; an updater for updating data items; and a version controller for keeping a historical version of each data item.

### DESCRIPTION OF DRAWINGS

In order to provide a better understanding, embodiments of the present invention will be described, by way of example only, with reference to the accompanying drawings, in which:

FIG. 1 is a block diagram of an information management method according to an embodiment of the present invention;

FIG. 2 is an illustration of a data object of the information management method shown in FIG. 1;

FIG. 3 is a schematic view of a graphical user interface according to an embodiment of the present invention;

FIG. 4 is an illustration of a data object according to an embodiment of the present invention;

FIG. 5 is a block diagram of an information management method according to an embodiment of the present invention;

FIG. 6 is a block diagram of an information management system according to an embodiment of the present invention;

FIG. 6A is an enlarged view of part of the information management system shown in FIG. 6;

FIG. 7 is a schematic view of a graphical user interface according to an embodiment of the present invention;

FIG. 8 is a block diagram of an information management method according to an embodiment of the present invention;

FIG. 9 is a flow diagram of an information management method according to an embodiment of the present invention;

FIG. 10 is a tabular view of a method used in the information management method shown in FIG. 9;

FIGS. 11 to 14 are further flow diagrams of the information management method shown in FIG. 9;

FIG. 15 is a block diagram of an information management system according to an embodiment of the present invention;

FIG. 16 is a schematic view of a graphical user interface according to an embodiment of the present invention;

FIG. 17 is a schematic view of a graphical user interface according to an embodiment of the present invention;

FIG. 18 is a schematic view of a graphical user interface according to an embodiment of the present invention;

FIGS. 19 to 22 are group selection diagrams illustrating various options of embodiments of the present invention;

FIG. 23 is a schematic view of a graphical user interface according to an embodiment of the present invention;

FIGS. 24 to 35 provide illustrations of various widgets of embodiments of the present invention;

FIG. 36 is a block diagram of an information management system according to an embodiment of the present invention;

FIG. 37 is a block diagram of a system for implementing a multiple user information management system according to an embodiment of the present invention;

FIG. 38 is a block diagram of another system for implementing a multiple user information management system according to an embodiment of the present invention;

FIG. 39 is a schematic diagram of functional modules of instructions for control of a computer to setup of an information management system according to an embodiment of the present invention; and

FIG. 40 is a schematic diagram of functional modules of instructions for control of a computer to implement an information management system according to an embodiment of the present invention.

### DETAILED DESCRIPTION

In the specification embodiments are used to provide examples of how one or more aspects of the invention may be implemented. Any one or more embodiments described herein may be used individually or in combination with one or more other embodiments, unless stated otherwise (such as where there is one embodiment and an alternative embodiment).

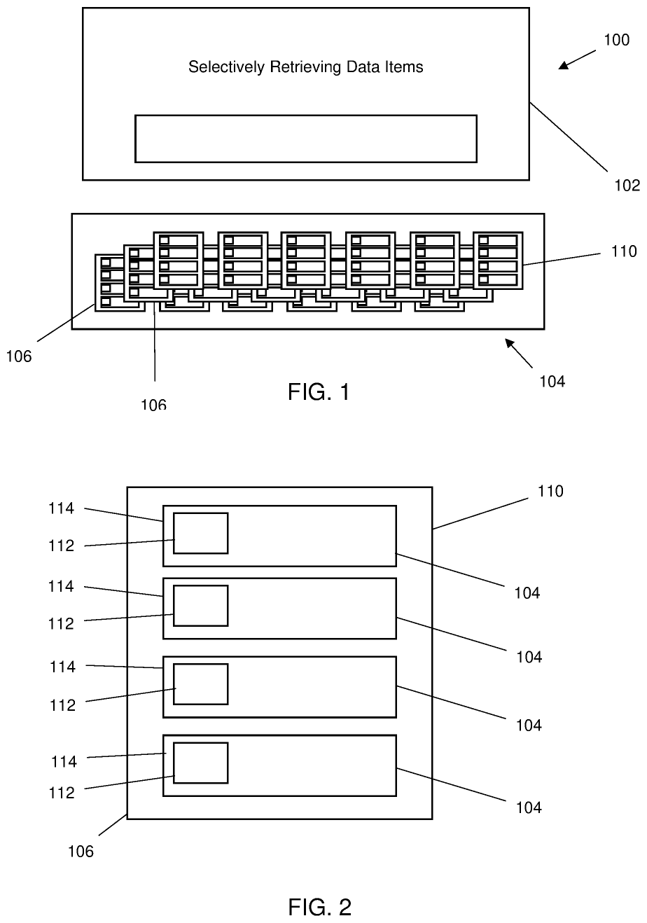

FIGS. 1 and 2 illustrate an information management method 100 according to an embodiment of the present invention. The method 100 includes, at block 102 selectively retrieving data items 104. The data items 104 are provided in connection with data objects 106 that are each associated with one or more of the data items 104.

At block 102, the method 100 includes selectively retrieving the data items 104 associated with a selected data object 110 based on access settings 112. The access settings 112 are each associated with a different group 114 of the data items 104 associated with the data object 110, with the data object 110 being associated with more than one group of data items 104. These associations are recorded.

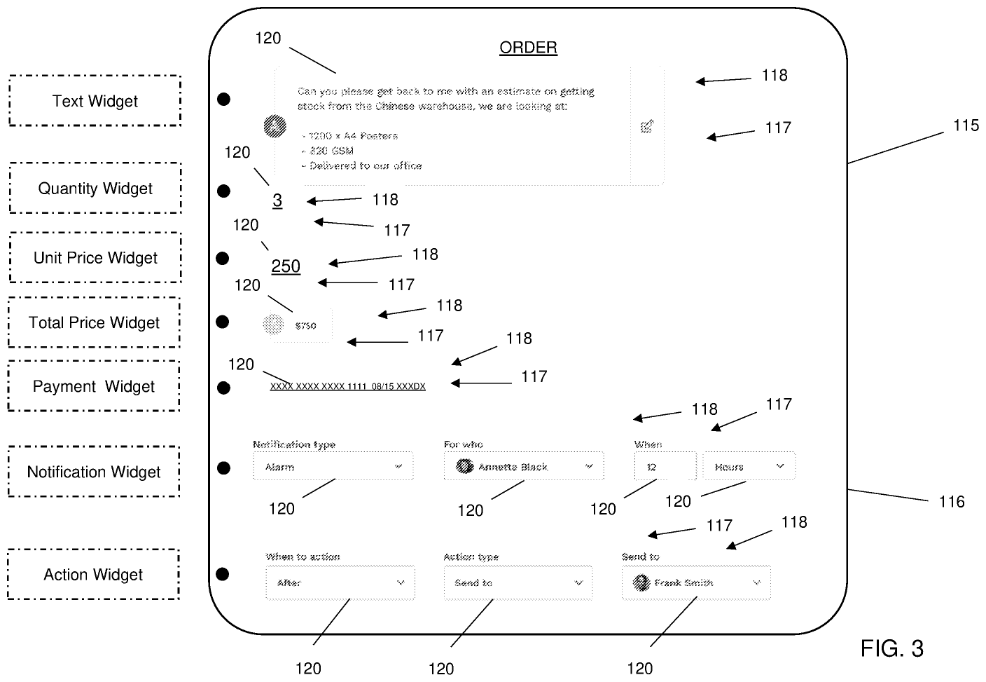

In an embodiment shown in FIG. 3, a selected data object 115 is associated with a layout 116 for visual display. A number of data items 117 are associated with the data object 115. Each of the data items 117 are associated with widgets 118 having fields 120. The widgets 118 each provide a component that performs the function of displaying data related to the data object 115. These associations are recorded.

FIG. 3 illustrates a text widget, a quantity widget, a price per unit widget, a total price widget, a payment widget, a notification widget, and an action widget. The data object 115 comprises an order form.

In FIG. 3, each of the data items 117 of the data object 115 is associated with a field 120 comprising an input field 120 or a display field 120. These associations are recorded. An example of a display field is provided by the total price widget where the display field value is equal to data content being the quantity widget value multiplied by data content being the price per unit widget value and the result is then rounded.

Each of the data items 117 is associated with a functional component, a display component and data content. These associations are recorded. The functional component derives from the nature of the respective widgets and the display component comprises the component displayed in combination with the data content associated with the widget.

In the embodiments illustrated in FIGS. 1, 2 and 3, the data items each form their own group. In other embodiments access settings can be associated with groups of data items such as data items 117. These associations are recorded.

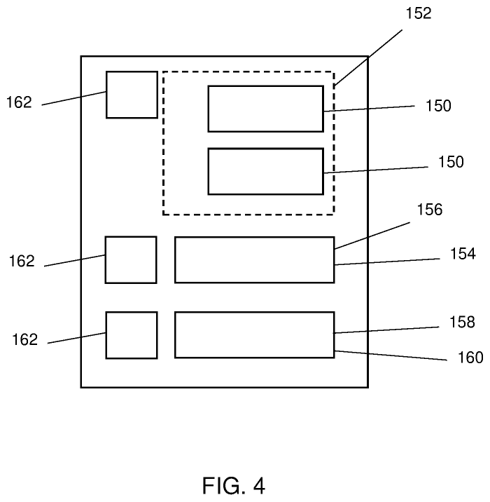

FIG. 4 provides an example in which access settings are associated with groups of the data items. In the embodiment of FIG. 4, two data items 150 form a first group 152, a second data item 154 forms a second group 156, and a third data item 158 forms a fourth group 160. Access settings 162 are associated with each of the group 152, 156 and 158.

In one embodiment groups are added and data items are able to be added to the groups with access settings being associated with each of the groups. In one embodiment, a builder is provided that allows groups of widgets to be dragged into layout areas that can each be associated with a different access setting. Accordingly, the associations can be defined and recorded by the builder.

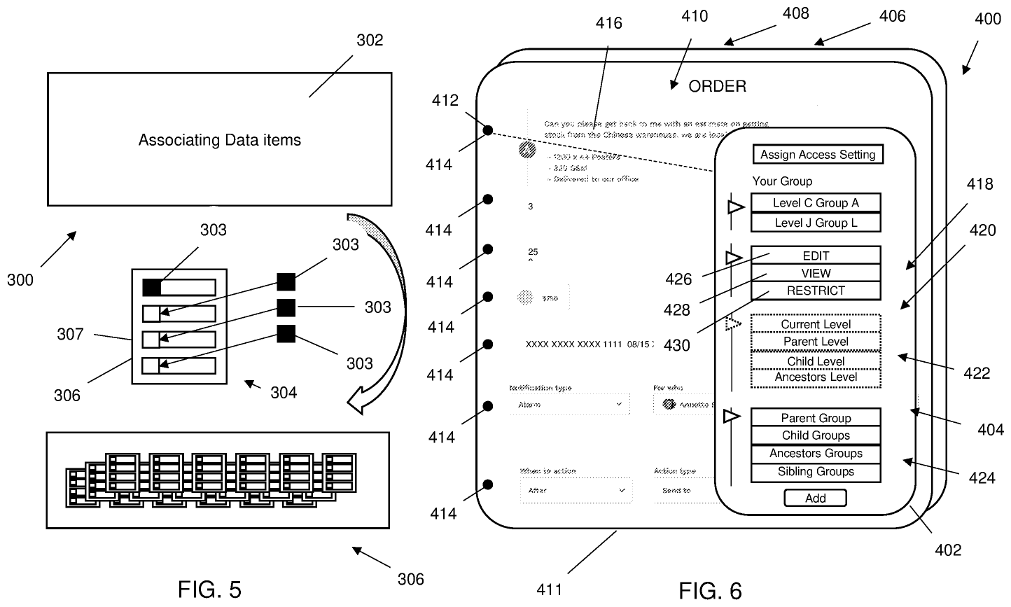

Referring to FIG. 5 there is provided an information management method 300 according to an embodiment of the present invention. The method 300, at block 302, includes associating access settings 303 with data items 304, in connection with data objects 306 each associated with one or more data items 304. The method 300 includes associating access settings 303 with different groups of the data items 304, associated with a selected data object 307, in a manner permitting each of the groups of the data items 304 to be associated with a different access setting 303, when the data object 307 is associated with more than one group of data items 304. In the embodiment each data items comprises a group. These associations are recorded.

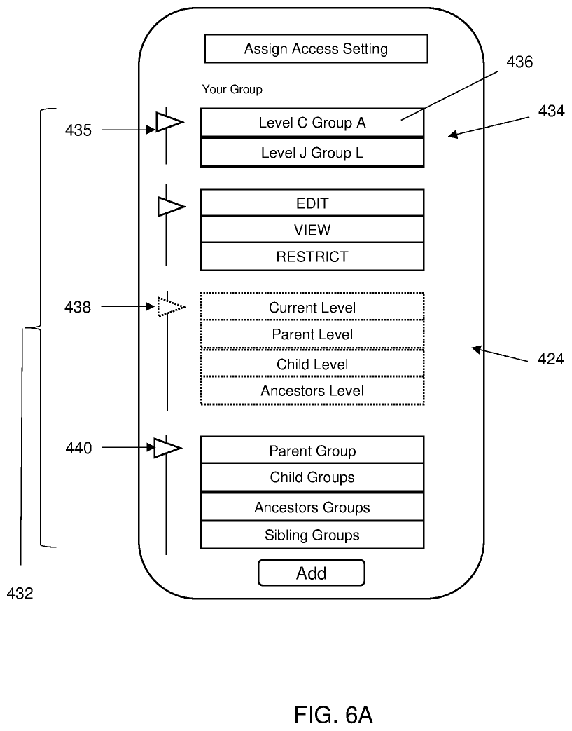

FIG. 6 illustrates a system 400 according to an embodiment of the present invention. The system 400 provides an associator 402 for associating access settings 404, in connection with data objects 406 each associated with one or more data items 408. The associator 402 is configured to associate access settings 404 with different data items 410 associated with a selected data object 411. The associator 402 is configured to permit each of the data items 410 to be associated with a different access setting 404, when the data object 411 is associated with more than one data item 410.

Using the associator 402 it is possible to assign an access setting to a data item 416. Assigning an access setting is achieved by activating a selector 412 associated with the data item 416. In the example of FIG. 6 a selector 414 is associated with each data item 410. Activating the selector 412 provides the ability to assign access settings 404 in the form of access permissions 418 in association with access setting groups 420. In the embodiment of FIG. 6, the access setting groups 420 are divided into those associated with levels 422, and those associated with groups 424. In another embodiment only those associated with groups are provided.

The access settings 404 include an editable setting type 426, a view-only setting type 428, and a restricted setting type 430. In one embodiment there is provided an editable setting type, a view only setting type and an obscured setting type. In one embodiment there is provided an editable setting type, a view only setting type and a hidden setting type. In one embodiment there is provided an editable setting type, a view only setting type, an obscured setting type and a hidden setting type.

In one embodiment the hidden setting type hides the entire data item from view when displayed. In one embodiment the obscured setting type obscures data content when the associated data item is displayed. Accordingly, the associations and setting can be defined/selected and recorded by the selector.

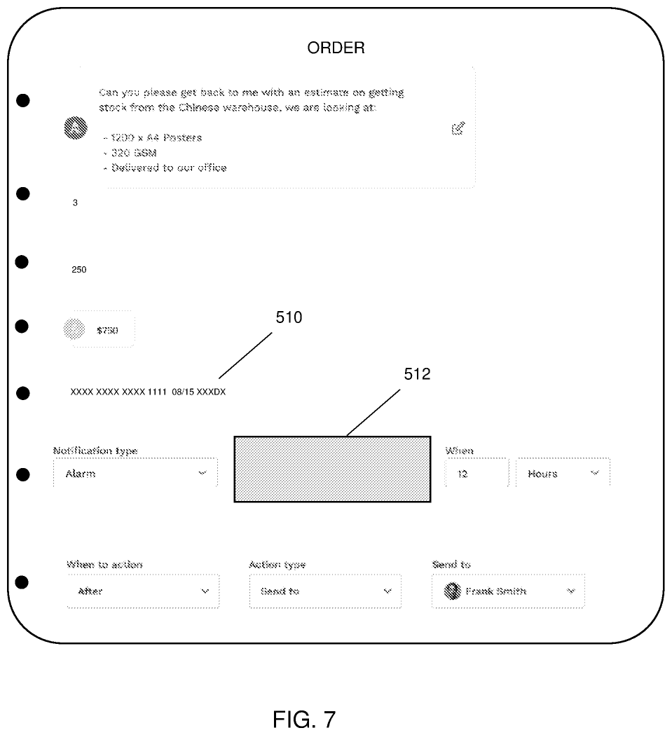

FIG. 7 provides an example of a payment details widget 510 being obscured and a notification widget 512 being obscured due to access settings. The payment details are obscured by the data content being partially replaced by the letter X. A notification widget 512 is partially obscured by the destination of the notification being covered.

The hidden setting type hides the entire display component of the associated data item from view. This is useful when the entire widget is to remain secret when the data object is shared.

In one embodiment the data items are associated with static content and one or more fields. The notification widget shown in FIG. 3, for example includes static content ‘notification type’, ‘for who’ and ‘when’ in combination with the visual layout. Four fields display data content. The notification widget in this manner has a functional component, a display component and data content. The obscured setting type when restricting access may obscure the one or more fields with the static content remaining viewable.

FIG. 6A illustrates selector 432 configured to allow a user within one or more groups of an organisational structure to select another group relative to a group 434 within which the user is positioned. As shown the selector 432 includes a selector component 435 allowing the user to select the group within which the user is positioned, when the user is a member of more than one group. In this example selections are made by moving a pointer along a slider where the selection is made according to which of the available selections the pointer is pointing at. In the embodiment of FIG. 6A, the component 435 has selected group 436 and the selector 432 provides the component 438 configured to select relative levels based on the selected group 436. A component 440 is configured to select relative groups based on the selected group 436. When component 438 is activated, the component 440 is deactivated and vice versa. In FIG. 6A the component 438 is deactivated by being shown in dashed lines. Deactivation occurs by selection.

The level selector 438 comprises full levels without having the same parent group. Other embodiments include only the group selector 440.

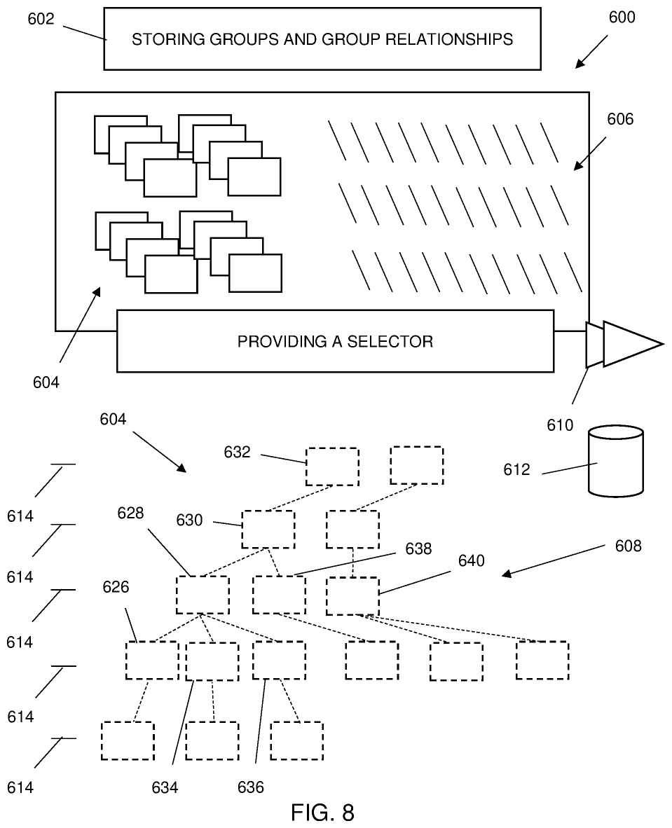

Referring to FIG. 8, a method 600 is provided according to a preferred embodiment of the present invention. At block 602 the method 600; includes storing groups 604 and group relationships 606. The group relationships 606 define associations between the groups 604 to define an organisational structure 608. The method 600 includes providing a selector 610 configured to allow a user within at least one group of the organisational structure 606 to select another group relative to a group within which the user is positioned.

In FIG. 8 there is shown a store 612 of groups 604 and group relationships 606. The group relationships 606 define associations between the groups 604 to define the organisational structure 608. In one embodiment a user is only able to be a member of a single group. In an alternative embodiment a user is able to be a member of more than one group.

FIG. 8 illustrates the structure 608 of an organisation. The structure 608 comprises the groups 604 divided into levels 614. Each group 604 is associated with a single group 604 in an immediately upper level 614. In the defined organisation structure a parent group is associated with child groups and the children of a parent group comprise sibling groups. A child group is restricted to having one parent group and being in a level immediately below the parent group. Accordingly the associations/relationships and positions defined by the selector 610 are recorded.

As an example, a group 626 has parent group 628 and ancestor groups 628, 630, and 632. Groups 626, 634 and 636 comprise siblings of the parent group 628. Groups 628, 638 and 640 are one level above group 626.

In one embodiment the access settings include organisational structure settings based on an organisation having levels, groups within levels, and child groups restricted to a single parent group in an immediately preceding level.

The sequential nature of levels and child groups being restricted to a single parent in combination with a selector configured to allow a user within a group of the organisational structure to select another group relative to a group within which the user is positioned allows for communication of data objects to be selected and thus controlled on this basis.

In one embodiment a selector component is provided for direct selection of users and groups in combination with a selector component for selecting groups relative to a group within which the user is positioned.

In an embodiment the various recorded associations etc. form part of the data object, alternatively the recorded associations etc. are associated with the data object. The data objects (and the recorded associations etc. if not part of the data object) are stored in a store of a information management system.

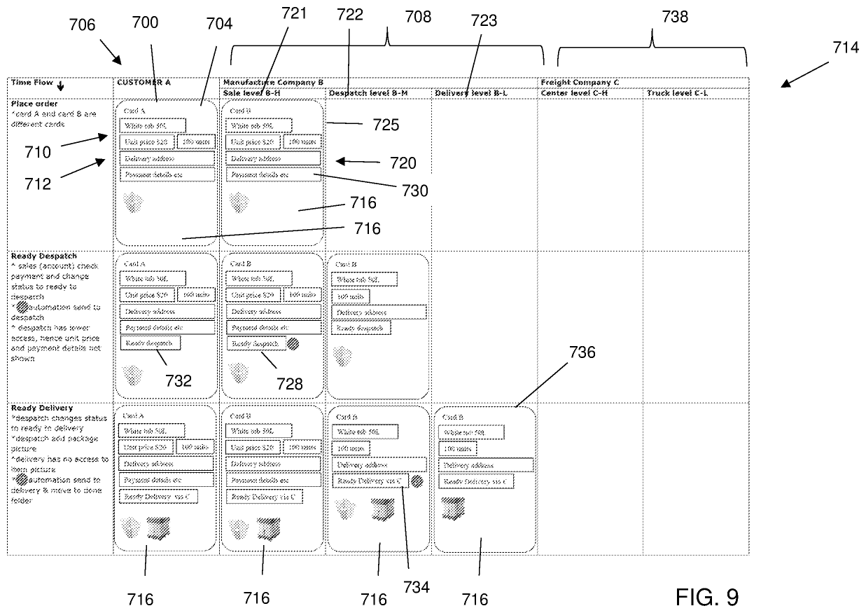

In the embodiment of FIG. 9, a data object 700 is able to be presented as and packaged for sending as a card 704 between users. The card 704 is sent from a first organisation 706 to a second organisation 708. In other embodiments more than one card is sent at a time. The incoming card 704 is listed in an ‘inbox’ of the second organisation 708. Card 704, while outgoing is listed in the ‘outbox’ of the first organisation 706.

In one embodiment, sending is achieved by selecting the card 704, right clicking send, and selecting a user. In other embodiments the card 704 is dragged into a chat box. In one embodiment a card is added by reference to a card name within a chat box.

In the embodiment of FIG. 9 the card 704 is associated with data items 710. Each of the data items 710 is associated with a field 712 comprising an input field or a display field. Access settings are able to be associated with each of the fields 712 independently.

A system 714 is provided that is able to associate data items for inter-organisation use and intra-organisation use. The cards are stored in a store of the system 714. The system 714 can be considered as providing linked data objects 716 that operate across a number of associated organisations. In the system 714 a copying process occurs when a card is shared between organisations.

Sending and receiving in the system 714 applies different rules in the case of intra-organisation access and inter-organisation access. The system 714 in this embodiment finds out if the receiver is from the same company and depending on the result provides link/delink options for inter-company access. Sending within the same company has linked data by default and users can select elements to delink. Sending outside the company has delinked data by default and users can select elements to link. Delinked data does not update.

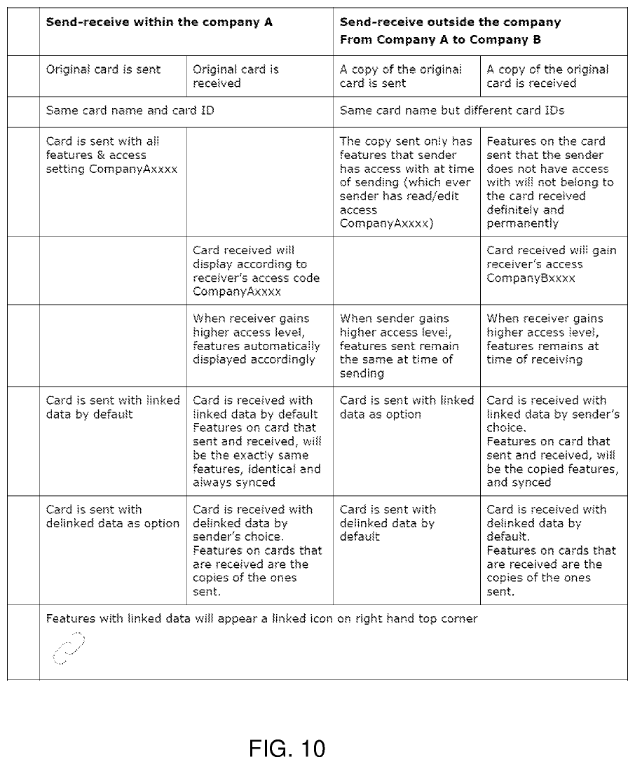

FIG. 10 provides a table illustrating the differences between inter-company and intra-company access. With reference to inter-company access, a single data object remains in the data store of system 714. The receiver is provided access to the data object and is able to manipulate the data items associated with the data object according to the access settings set by the user who created the data object. When the receiver gains a higher access level, the access settings automatically apply to the receiver's higher access level.

In the case of inter-company sharing, FIG. 10 shows that the original card is received in the sense that no further unique data object identifiers are created in the system 714. Access by the receiver is in association with the same data object identifier.

For intra-organisation sending, a new data object is created in the data store of the system 714 with an association identifier indicating that the associated data object and new data object are linked and constitute linked data objects. Links are associated with the data items of the respective linked data objects. The sender only has access to corresponding data items that the sender had the ability to access at the time of sending. When sending inter-organisation, a number of link settings are provided selectively associating the data items of different data objects. The link settings define update rules between associated data items of different data objects.

The advantages of creating a new data object are as follows. Firstly, if the sender decides to remove their account in its entirety from the system 714, less database manipulation may be required in that there is no need to create distinct data objects for organisations that previously shared data objects with the sender organisation. Secondly, exports made by the receiving organisation will not necessarily involve data objects directly associated with the sending organisation.

In the embodiment described copying comprises a data store operation. As would be apparent other embodiments may not copy and may create linked data items at a data store level for intra-organisation sharing.

Returning to FIG. 9, the card (card A) is sent from the first organisation 706 to the second organisation 708. The receipt of the sent card from a different organisation (the second organisation 708) causes the creation of a new data object 725 with the access settings specified by the first organisation 706. The data items 710 are associated with the data object 704 and are linked with newly created data items 720 associated with the newly created data object 725 on the basis of the access settings set by the first organisation 706. Data object 725 may be presented as a different card (card B) to one or more users of the second organisation 708.

In one embodiment the second organisation 708 comprises a first group 721, a second group 722 and a third group 723. The sender from the first organisation 706 defines access settings for data items 720 for the first group 721. In this example, the first group 721 comprises sale level group 721. Further the sender provides edit access settings set in association with data item 720 including a status data item 728. The status data item 728 may be added by the first group 721 when the data object 725 is created. The status data item 728 may be a drop down menu widget. A default status may be set when the status data item 728 is created, such as ‘Awaiting payment’. A user from the first group 721 can change the drop down menu item 728 to ‘Ready Dispatch’ when the payment is received. In a further example this change may be automated, as described further below. In that case, one of the items available to selection may be an ‘empty’ datum. In the case of the ‘empty’ datum being selected, the widget may not be displayed as this the case in the ‘Place order’ row. When it is changed to a status other than ‘empty’ it and the selected status will then be displayed. Using this technique as an alternative to adding it, the status data item 728 may have been in card A when it was sent, but was not displayed.

The sender provides restricted viewing access settings in relation to all levels below the sale level of the receiving organisation for a payment details data item 730 and the unit price data item. Thus, when the card B is sent to a user of the second group 722, the payment details data item 730 and unit price are not sent or they can be obscured (eg. blacked out or blurred out) or the data item can be hidden in the card (not shown) when they are of a lower level in the organisational structure. The access settings can be set as described above by the first group 721.

The data item 728 in card B is linked to data item 732 in card A. So, for example, when data item 728 is changed to ‘Ready Dispatch’, data item 732 will be automatically updated to ‘Ready Dispatch’.

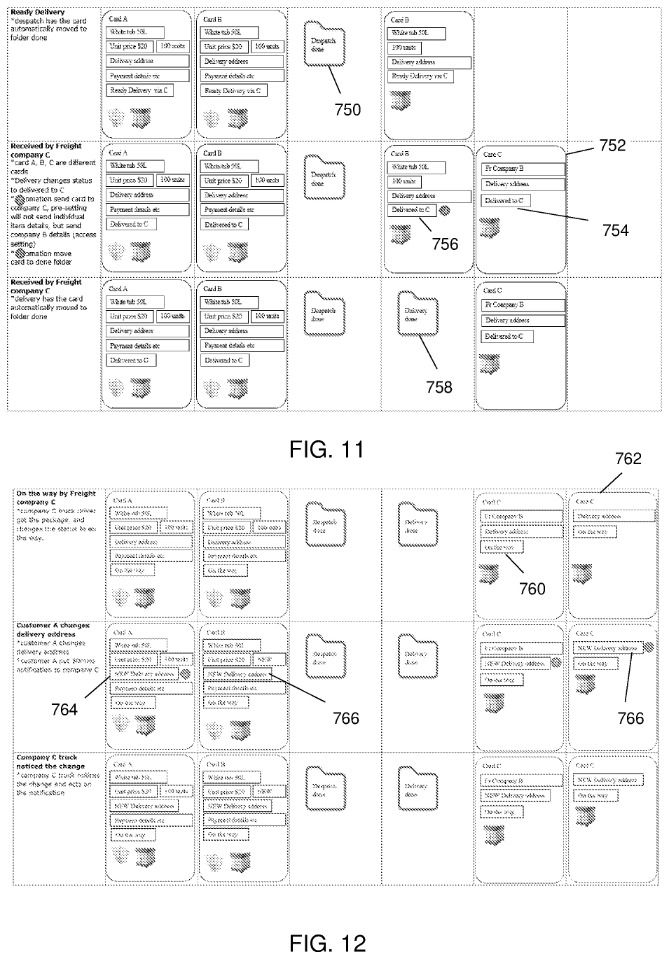

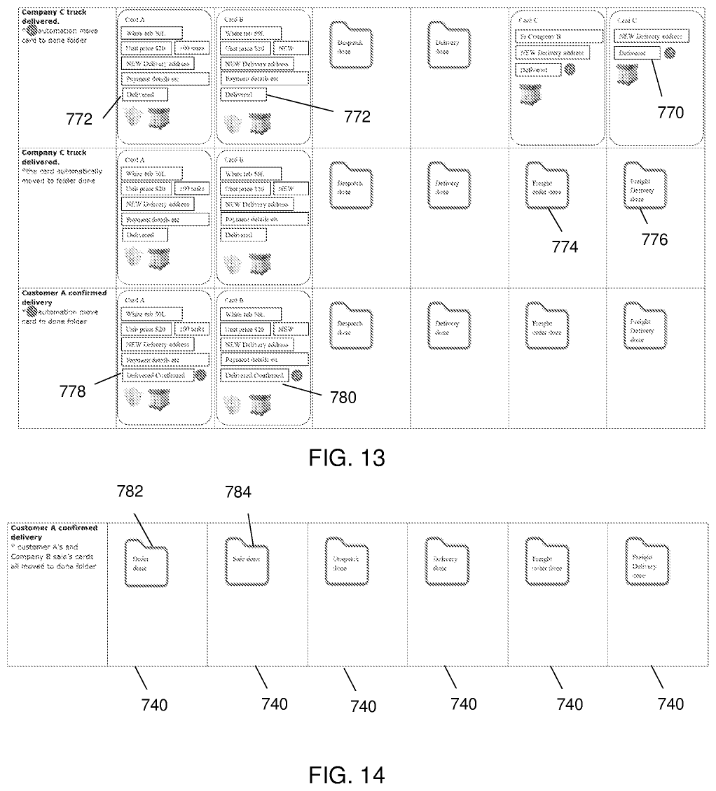

The sender provides a trigger data item (not shown) configured to execute an action in response to an update of the status data item linked with status item. For example, when the second organisation 708 updates the linked status data item 728 to ‘Ready Dispatch’ a linked data object 736 is automatically provided to a user of the third group 723 of the second organisation 708 across the ‘Ready Delivery’ row. This occurs as a result of an automation data item (not shown) specified by the sender. For example, second group 722 gets the item being shipped from a warehouse (for manufactures on demand) and gets the shipment ready, such as by placing it on a pallet. Group 722 may change the status drop down widget 734 to ‘Ready Delivery via C’. This is linked to the other cards and so is updated across the ‘Ready Delivery’ row. An action widget associated with ‘Ready Delivery via C’ status will send the card to group 723 and also move the current card for 722 to folder ‘Despatch Done’ 750 in FIG. 11. Group 723 will find the pallet and deliver it to group 738 (which is company C). Once the pallet has been delivered to third organisation/group 738, group 723 will change the status drop down widget to ‘Delivered to C’ at 756. An action widget associated with ‘Delivered to C’ status will send a new card (card C) 752 to group 738 and also move the current card for 723 to ‘Delivery Done’ folder 758. This change is replicated by the data items being linked to card A and card C. Referring to FIG. 12, a user of group 738 then changes the status drop down widget to ‘On the way’ 760 once the final delivery is in process. This may copy card C to the truck driver at 762. In an example, group 700 changes the delivery address (in time for the change to have effect—say 30 minutes before delivery) at 764. This is replicated at 766 and an alert is also generated indicating that a time critical change has been made. Group 738 may then change the status drop down widget to ‘Delivered’ 770 in FIG. 13 once the final delivery is made. An action widget associated with ‘Delivered’ will move card for group 738 to folders ‘Freight order done’ 774 and ‘Freight Delivery done’ 776.

The first organisation 706 can then update the status item to ‘Delivery Confirmed’ at 778, which updates the status in card B at 780. Card A is the moved to ‘Order done’ folder 782 and card B is moved to ‘Sale done folder’ 784 in FIG. 14.

In one embodiment a chain of data updates serves to synchronise data items between more than two linked data objects. In the embodiment of FIG. 14 cards are moved to finalised folders 740 but are still linked. As illustrated in the above example, when the one organisation (eg. third organisation 738) updates a data item, a link between the data item and status item causes the status item to update. A link between the data item 732 and the data item 728 causes the data item 728 to update. In this manner linked data items settings are provided between the original sender and one or more receiving organisations.

In this manner linked data items settings are provided between the original sender and one or more receiving organisations.

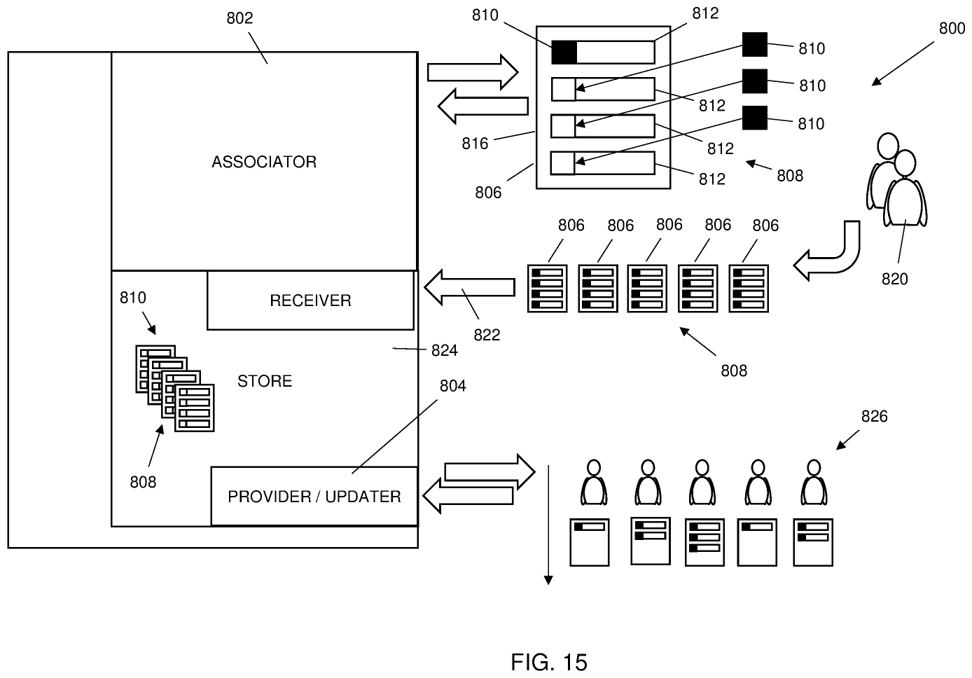

FIG. 15 illustrates a further preferred embodiment of the present invention. A system 800 is provided. The system 800 includes an associator 802 and a provider 804 in connection with data objects 806 each associated with one or more data items 808.

The associator 802 is configured to associate access settings 810 with each data item 812, associated with a selected data object 816, in a manner permitting each of the groups of the data items 812 associated with the data object 816 to be associated with a different access setting 810, when the data object 816 is associated with more than one group of data items 812. The association is stored in a store 824.

The provider 804 is configured to selectively retrieve data items 808, in relation to the data objects 806, based on access settings associated with different groups of the data items associated with each data object 806, when the data object 806 is associated with more than one group of data items.

In one embodiment, users 820 create data items 808 in relation to data objects 806 which are stored at block 822 in the store 824. The provider 804 selectively retrieves the data items 806 of the data objects 808 in response to access requests from a number of users 826. The provider 804 selectively retrieves the data items 808 in a manner restricting access to the data items 808 based on the access settings 810. The access settings 810 specify restriction options including obscuring data values associated with the data items 808 and/or entirely hiding data items 808.

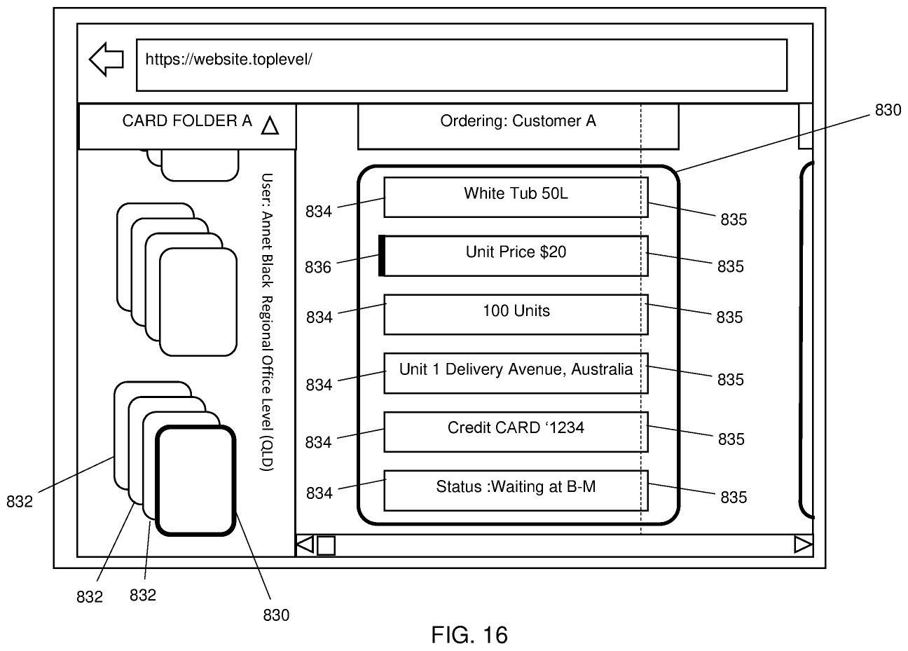

Referring to FIG. 16 a data object 830 is provided and stacked on top of other data objects 832. The data object 830 includes a number of data items 835 in the form of a number of display fields 834 and a number of input fields 836. By having access settings applied to each data item 835 independently, the user is able to change a unit price through a computer interface updating the data content associated with the data item 835 while being restricted from editing other fields.

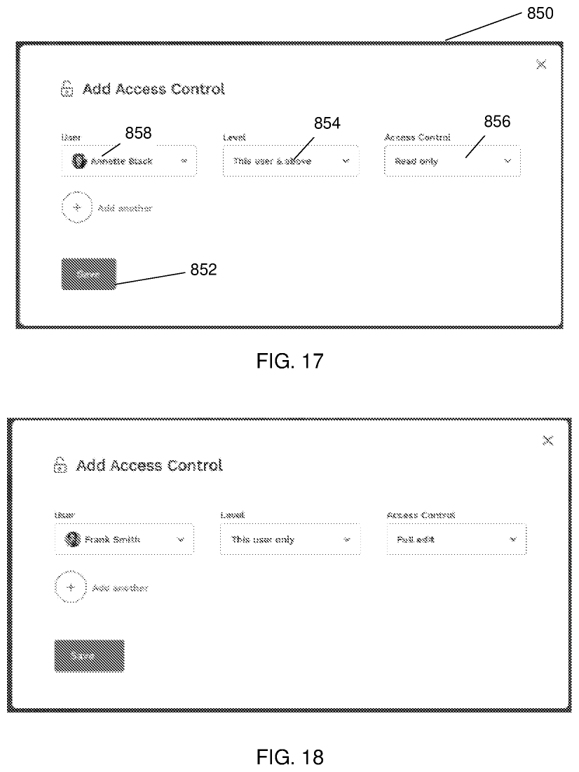

In relation to a data object in which a user has an editing right, the original creator (user) is provided with access level settings. This allows the creator to select a level and apply permissions in connection with the level. FIGS. 17 and 18 provide examples of a graphical user interface 850. The user is provided with an access control′ button 852 to set access requirements in relation to data items.

An access pop up screen has a user level selector 854 and access control selector 856. A user section 858 lists all employees of the same company. The user level selector 854 lists three options: ‘This user only’, ‘This user's block and above’ and ‘This user's level and above’. If there is only one user in that block selection of ‘This user's block and above’ will in effect be (and may be displayed as) ‘this user and above’.

In this context, by block it is meant a position in the hierarchy as shown by example in FIG. 8, such as 626, 634, 636, which represent a certain position in an organisation. Multiple users can be assigned to a block. Users in a block have unique access to data objects within the organisation. All users in the same block have the same access settings.

The selection ‘this user only’ means that the associated data-item is only accessible by the selecting user and the selected user. The selection ‘users in the same block’ means that the associated data-item is only accessible by the selecting user and the selected users in the same block. The embodiment provides a standard option of directly selecting users.

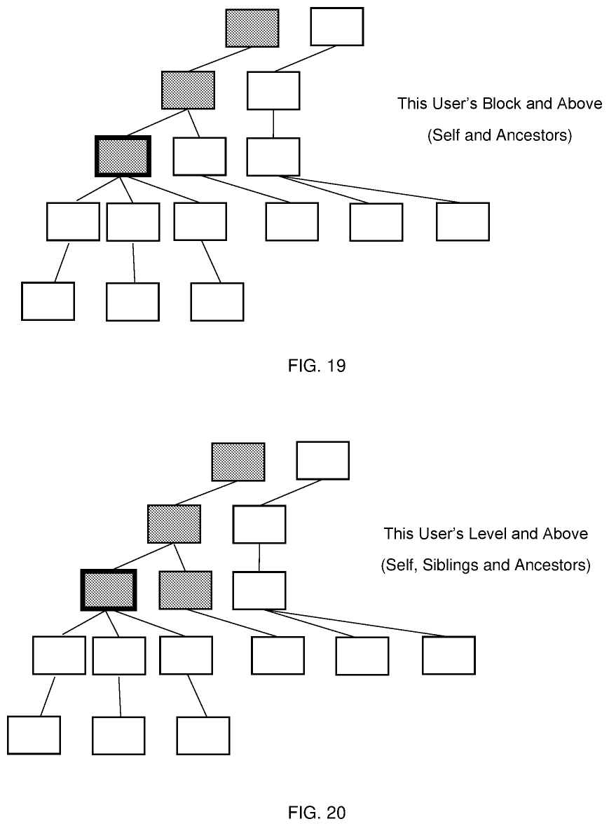

The selection ‘This user's block and above’ means this element is only accessible by the selecting user, the selected user's block and the users from groups (or blocks) in the direct up-stream of the selected user. This is illustrated in FIG. 19. In the embodiment the selecting user is always provided access.

The selection ‘This user's level and above’ means this element is only accessible by the selecting user, the selected user's block, the selected user's direct level and the users in the direct up-stream of the selected user. Notably this does not extend across the full level but rather only to siblings of the same parent and ancestors. This is illustrated in FIG. 20.

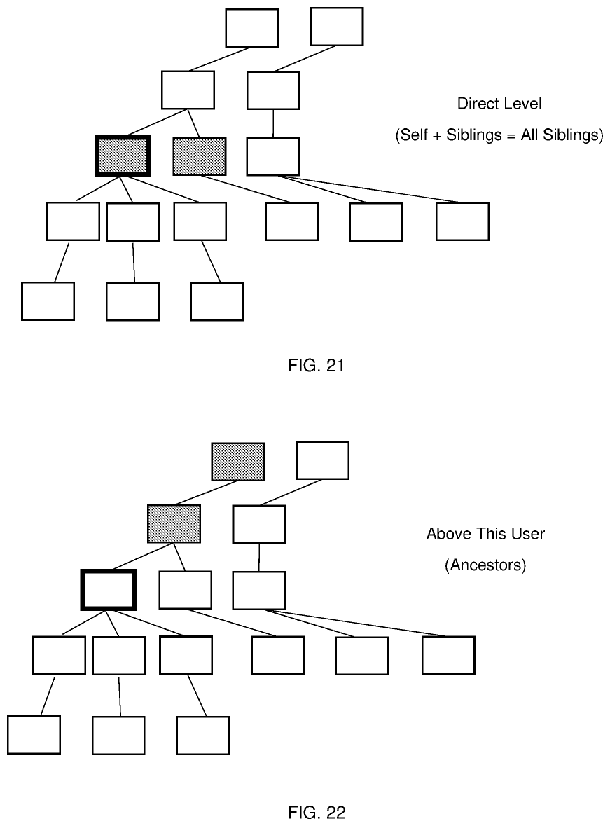

The selection ‘Direct level’ or ‘same level’ means the org-chart blocks (groups) which have the same direct above block. Notably this does not extend across the full level but rather only to siblings of the same parent and ancestors. This is illustrated in FIG. 21.

The selection Direct up-stream′ means the org-chart blocks above and with up-steam only without horizontal related blocks. This is illustrated in FIG. 22. As before, the selecting user is always provided access.

The ‘access control’ section 856 list typically has three options: ‘Read only’, ‘Hide’, and ‘Edit’. In a variation there may also be a fourth option of ‘obscured’, in which the data is blurred or blacked out. In contrast when the access control is hide it is not shown.

The option ‘Read Only’ means the item is shown to the user but cannot be edited. The option ‘Hide’ means the item is shown to the user but blurred. The option ‘Edit’ means the element is shown to the user and editable.

Multiple access requirements can be added to an item.

One embodiment provides a selector allowing selection of: (i) a self and ancestor groups setting; (ii) a self, sibling and ancestor groups setting; (iii) a self and sibling groups setting; and (iv) an ancestor groups setting. The selecting user is always provided access but not necessarily the users group. The selection is stored in the store 824.

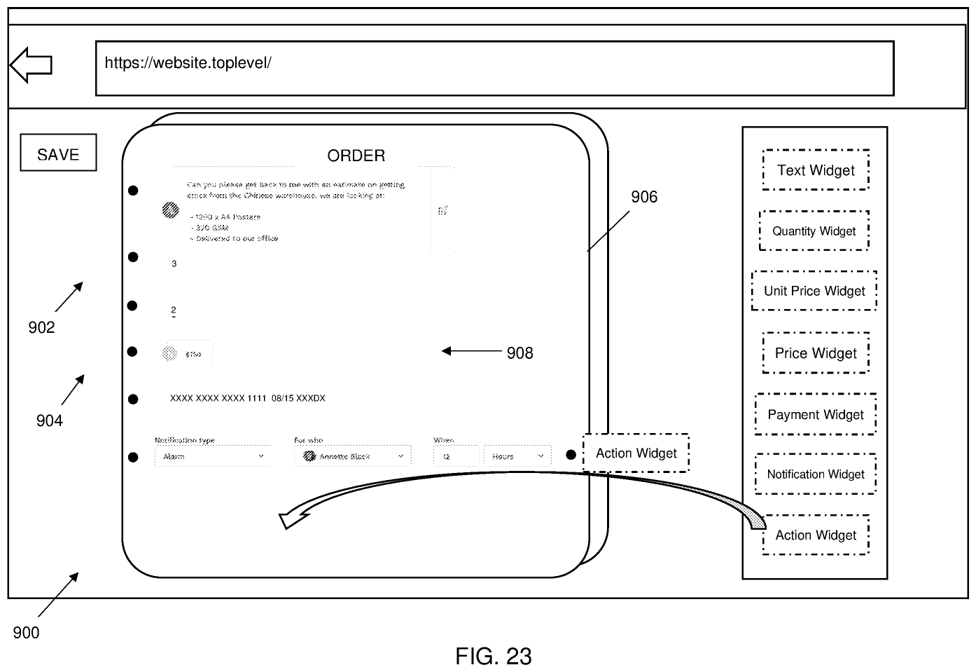

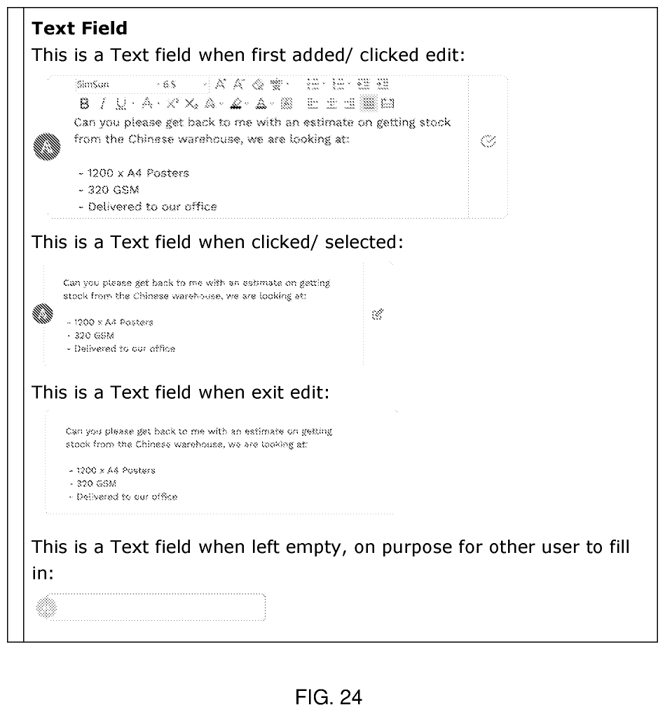

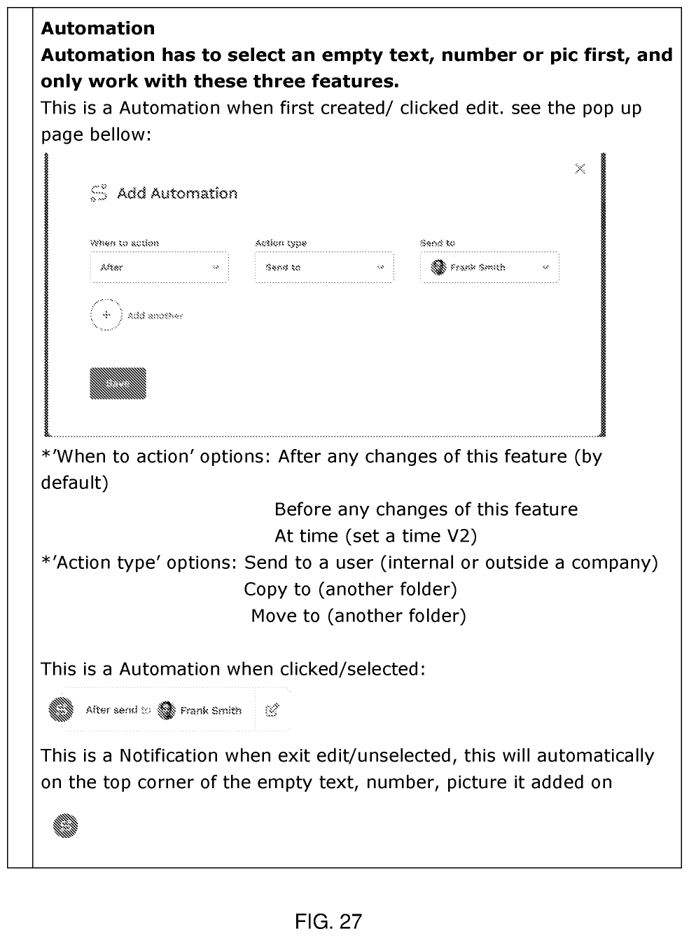

FIG. 23 illustrates an information management system 900 according to a further embodiment of the present invention. The information management system 900 comprises a builder 902 and a customizer 904. The builder 902 is provided for creating data objects 906 having data items 908, the data items of each data object for visual display. The customizer 904 is configured to allow access settings to be specified for different groups of data items associated with a data object. In the embodiment data items are dragged and dropped from a visual grouping of data item types. Various data item types are illustrated in FIGS. 24 to 35.

In one embodiment a text data item type comprises a text field type. A text field type is associated with an input field and a display field. A text field may be left empty for a user to fill in as illustrated in the example of FIG. 24.

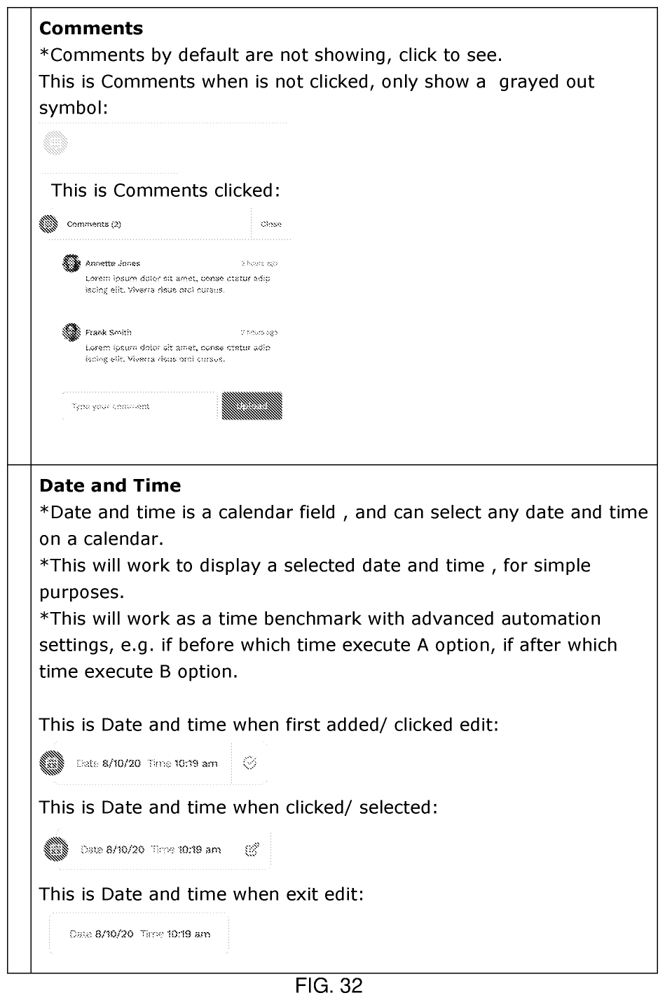

In one embodiment a date and time item type comprises a date and time field type. A date and time field type is associated with an input field and a display field. A date and time and field may be left empty for a user to fill in as illustrated in the example of FIG. 32.

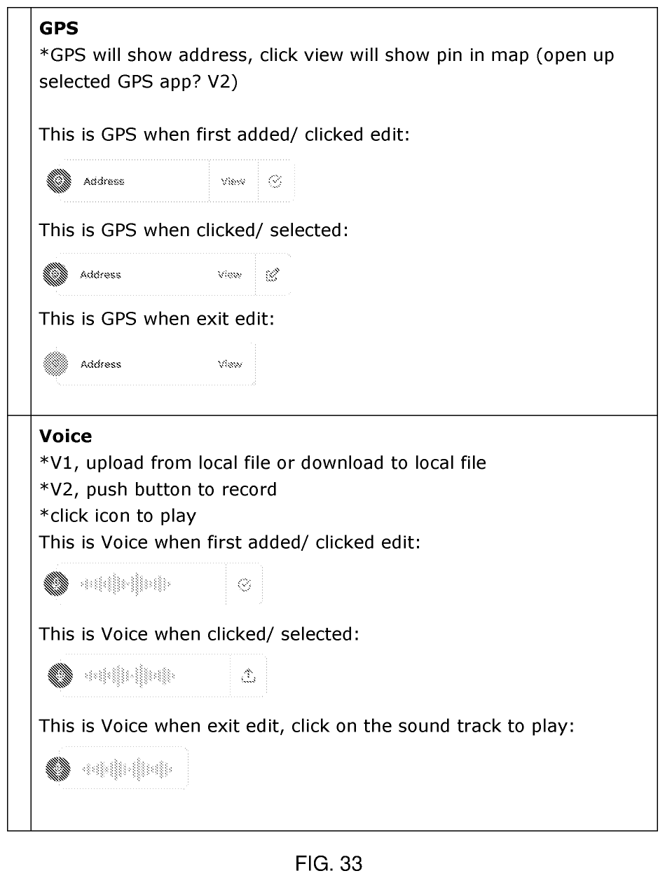

In one embodiment a location data item type comprises a location field type. A location field type is associated with an input field and a display field. A location field may be left empty for a user to fill in as illustrated in the example of FIG. 33.

In one embodiment a voice data item type comprises a voice field type. A voice field type is associated with an input field and a display field. A voice field may be left empty for a user to fill in as illustrated in the example of FIG. 33.

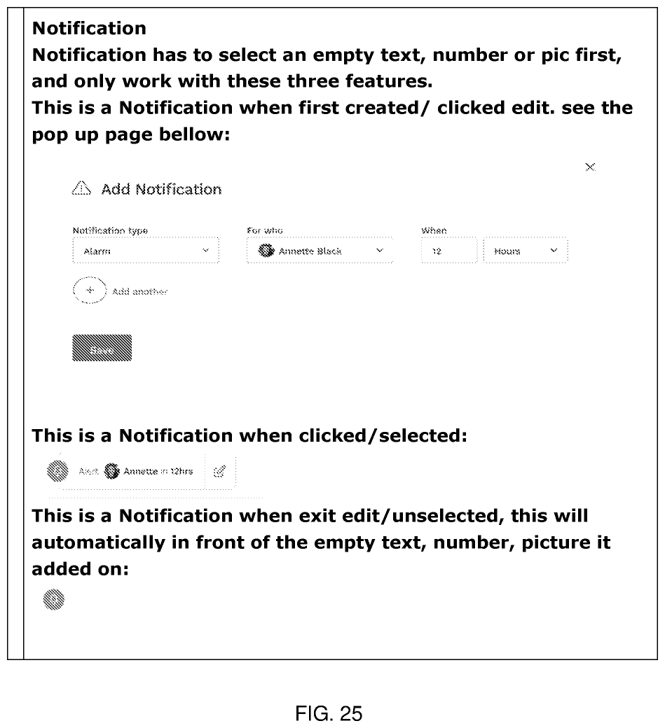

In one embodiment a notification data item type will automatically send a notification after a number of hours as illustrated in the example of FIG. 25.

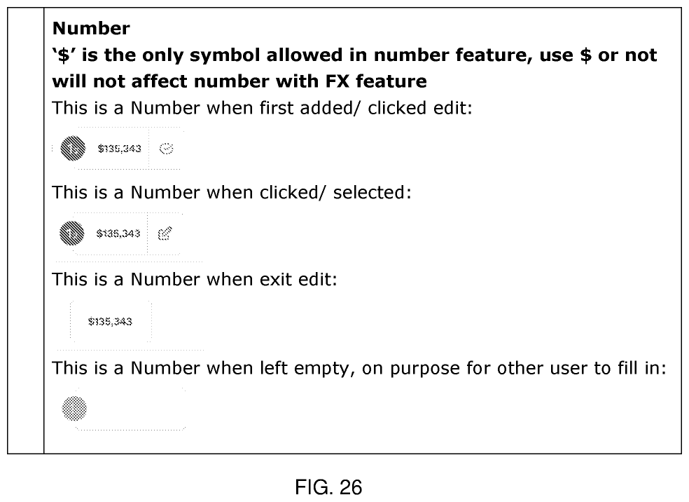

In one embodiment a number data item type is associated with a number field type as illustrated in the example of FIG. 26.

In one embodiment a currency number data item type is associated with a currency number field.

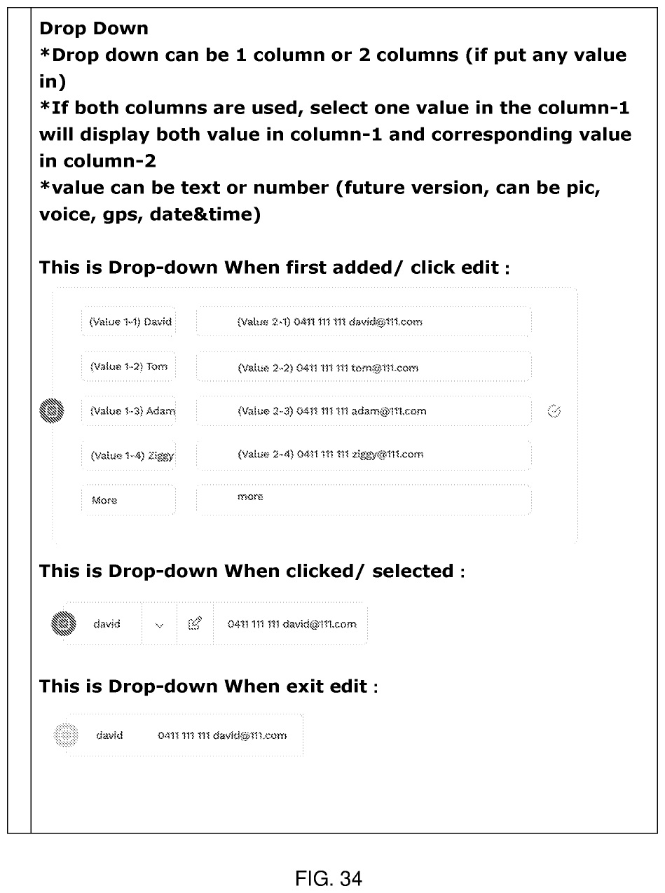

In one embodiment a drop down data item type is associated with a drop down field as illustrated in the example of FIG. 34. In one embodiment two columns are provided.

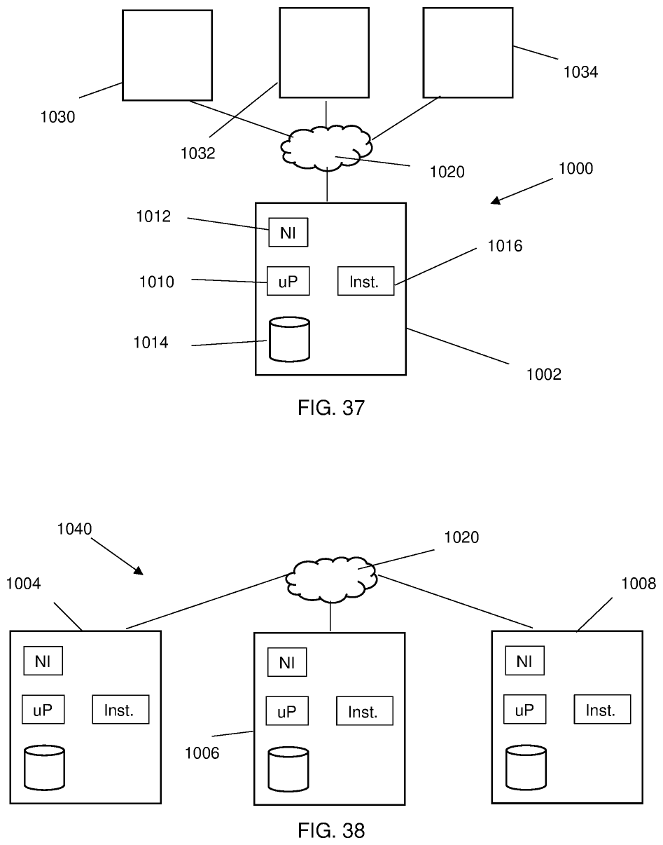

In one embodiment an automation data item type is associated with an action trigger, an action time and a notification action as illustrated in the example of FIG. 37. It is a requirement that the notified user has access to the data object.

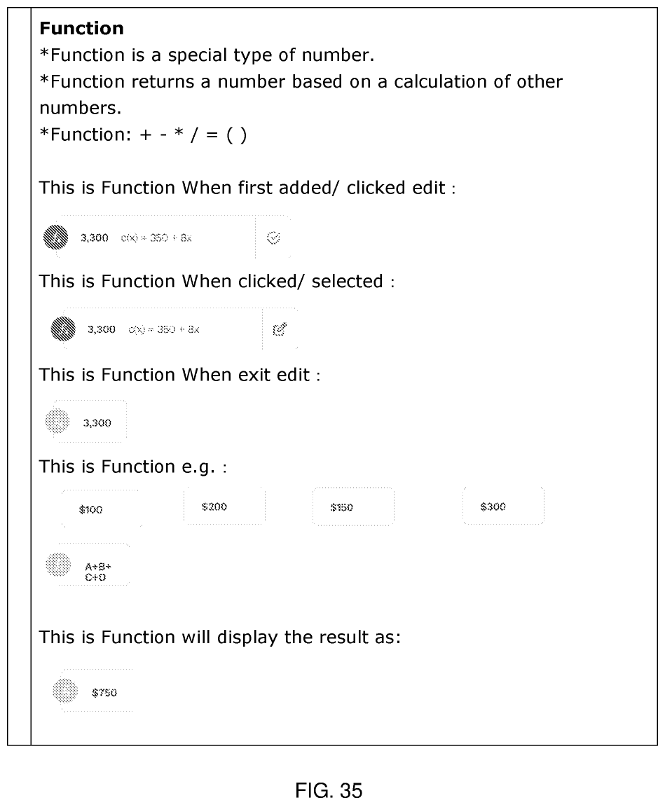

In one embodiment a function data item type comprises a calculation field that is based on values associated with other data items associated with the data object with which the corresponding data item is associated as illustrated in the example of FIG. 35.

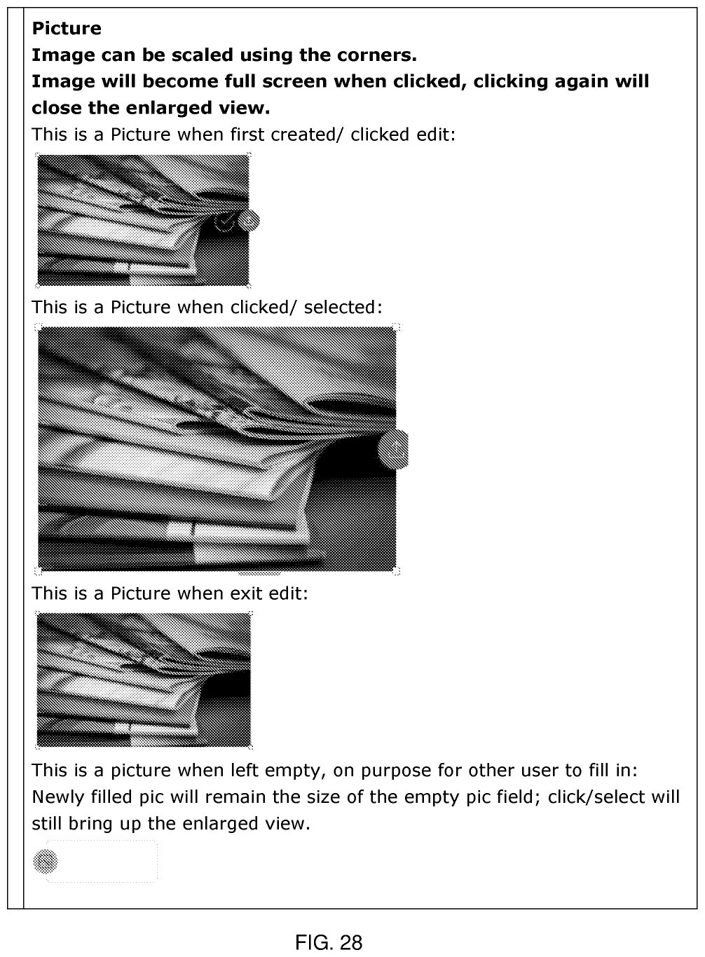

In one embodiment a picture data item type comprises a picture field type as illustrated in the example of FIG. 28. A picture field type is associated with an input field and a display field. A picture field may be left empty for a user to fill in.

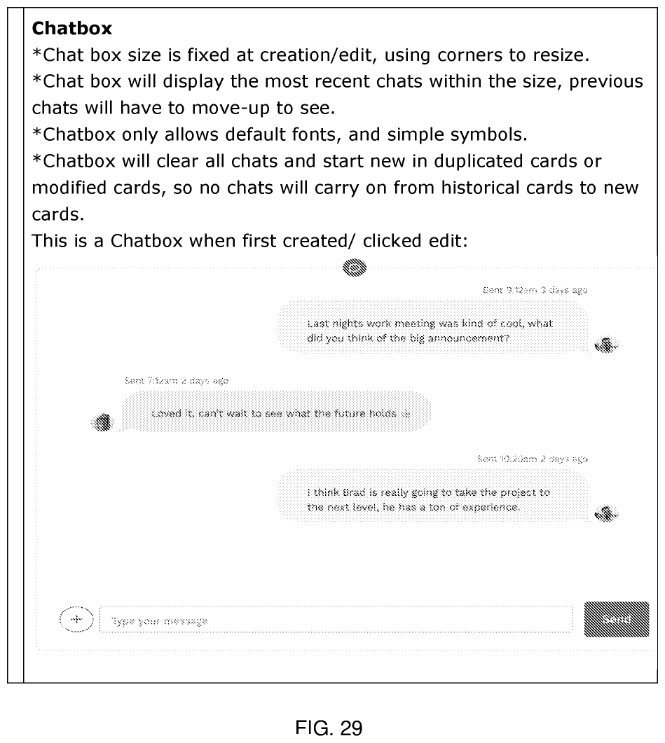

In one embodiment a chat box item type is provided as illustrated in the example of FIG. 29. The chat box item type provides access to a chat box for users having access setting rights. The chat box item type allows users to communicate and for messages to be displayed in a chat area. The provision of a chat-box intra-organisation allows for multiple organisation users to communicate in connection with a data object. The provision of a chat-box inter-organisation allows for multiple organisations to communicate in connection with a data object.

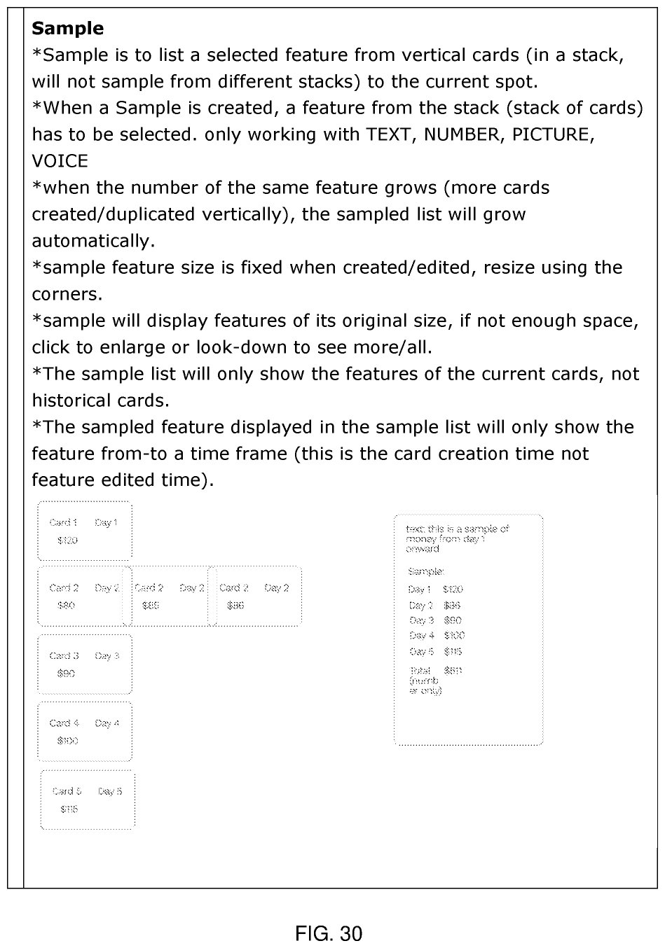

In one embodiment a sample data item type comprises a display field type showing data associated with one of more data objects as illustrated in the example of FIG. 30. In one embodiment the one or more data objects are associated by being grouped for visual display. In one embodiment the visual display comprises stacking. In one embodiment the one or more data objects are associated by being located in a folder. The provision of a sample data item type allows for the presentation of data relating to one or more data objects.

In one embodiment a sample data item is created by selecting a feature from a group of cards. A text, number, picture of voice type selection is made from the group of cards. When a data object is duplicated in a group the sampled list will grow automatically. The sample list shows the features of current cards, not historical cards. For example, if the sample feature comprises a number feature at a set position in relation to each of the data cards.

In one embodiment assess rights to the historical version of each data object/data item are according to the current access rights to the current version of each data object/data item.

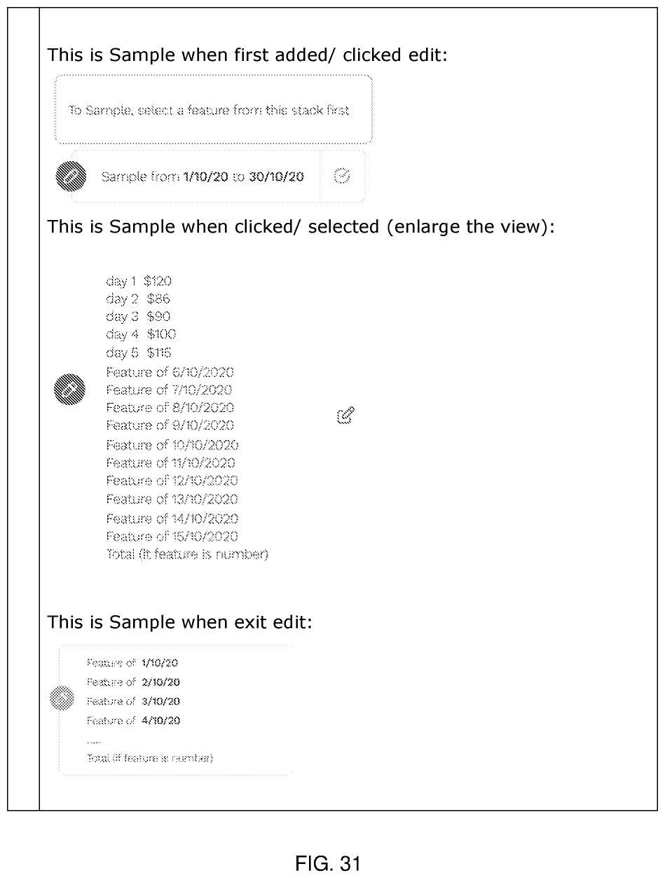

When the sample widget is first created, system will require one existing datum or widget to be selected, and this datum/widget will be listed in the sample widget as illustrated in the example of FIG. 31. When editing a sample widget, more or less data can be selected as extra or less columns of the sample widget. When editing a sample widget, starting and ending times can be defined, so only data/widgets within the time period will be sampled in the sample widget for display. If number data is sampled, a sum total will display at the end of the list.

A sample widget and the selected data/widget to be sampled, can be from the same folder or stack of cards, or can be from different folders or cards. However, all data/widget sampled in a sample widget are from the same stack of cards.

In one embodiment of the present invention a sampler is provided for sampling data items in connection with data objects each associated with one or more data items; wherein the sampler is configured to sample data items associated with a group of data objects. The group of data objects may comprise data objects grouped together using a grouping identifier.

Yet further embodiments include storing data items, in connection with data objects each associated with one or more data items; updating the data items and keeping a historical version of each data item, as the data item existed before an associated update.

In one embodiment there is provided a store for storing data items, in connection with data objects each associated with one or more data items; an updater for updating data items; and a version controller for keeping a historical version of each data item, as the data item existed before an associated update.

When a card is multiplexed, the cards from the same origin together become a stack of cards. A newer card is on the very top of a stack, all cards are visible and in the order in their vertical position in the stack.

When a card has been modified or any data changes on the card, the older card become the historical card, and s newly saved card become the current card. Current card is always visible, historical cards are tucked behind the current card on the horizontal position.

A card can be copied, sent to other location and starting from a new stack of cards. However, a card cannot be moved out from a stack or moved into an existing stack.

Each save will create a historical card. Historical cards cannot ordinarily be deleted. Cards, stacks and folders with data cannot be deleted. Ordinarily only an empty folder, stack or card can be deleted.

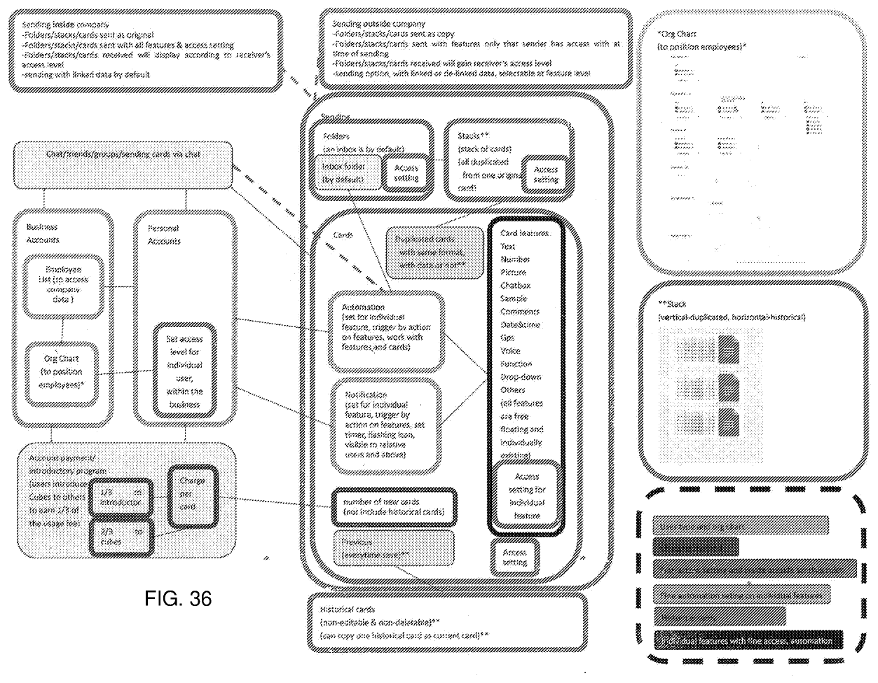

FIG. 36 provides an illustrative overview of a further system according to an embodiment of the present invention.

FIG. 37 shows a system 1000 for implementing embodiments of the information management system described above. It comprises a computer 1002 (which will typically be configured to operate as a network enabled server) comprising one or more processors 1010 which are controlled by instructions 1016. The computer also comprises a storage device 1014 for storing data (inclusive of the data objects, and in an embodiment the associations, relations, selections etc. in relation to it, as described above) and a network interface 1012 for connection of the computer to a computer network 1020, such as the Internet. The system 1000 also comprises a plurality (three are illustrated) computers 1030, 1032 and 1034, for use by users of the information management system. The computers 1030, 1032 and 1034 communicate via the network 1020 with the server 1002. The computers may have a browser to present information and receive input to/from the user which is generated by the server as a webpage, or a local application may receive data from the server and present information and receive input to/from the user. This may be a typical computer network with a centralised server. However, the substantive difference from a typical implantation of the centralised server is specific configuration of the server to operate as an information management system by the instructions, which will typically be in the form of computer program(s), examples of which is functionally described herein. When loaded with the computer programs the server is configured as a specific purpose machine andyy is no longer generic in that (while it may still be capable of performing other generic functions) it is able to perform the specific functions described herein.

FIG. 38 shows a system 1040 for implementing embodiments of the information management system described above. It comprises a plurality of computers (three are illustrated by example) 1004, 1006 and 1008 which are network enabled. These may be implemented by for example desktop computers or as servers (each of which is able to be accessed by one or more other computers on a local network in the typical manner a local network is implemented in an organisation). Each computer 1004, 1006 and 1008 are controlled by instructions similar to instructions 1016 Each computer 1004, 1006 and 1008 may have a storage may be similar to storage 1014. The computers 1004, 1006 and 1008 are able to communicate with each other via the network 1020. The computers are configured to present information and receive input to/from the user. Each computer for example implements a part of the information management system for the respective user (or users for the respective organisation). Again, the substantive difference from a typical implantation of a personal computer or organisation server is specific configuration of the computers 1004, 1006 and 1008 to operate as their respective part of the information management system by the respective instructions, which will typically be in the form of computer program(s), examples of which is functionally described herein. When loaded with the computer programs each of the computers 1004, 1006 and 1008 is configured as a specific purpose machine and is no longer generic in that (while it may still be capable of performing other generic functions) it is able to perform the specific functions described herein.

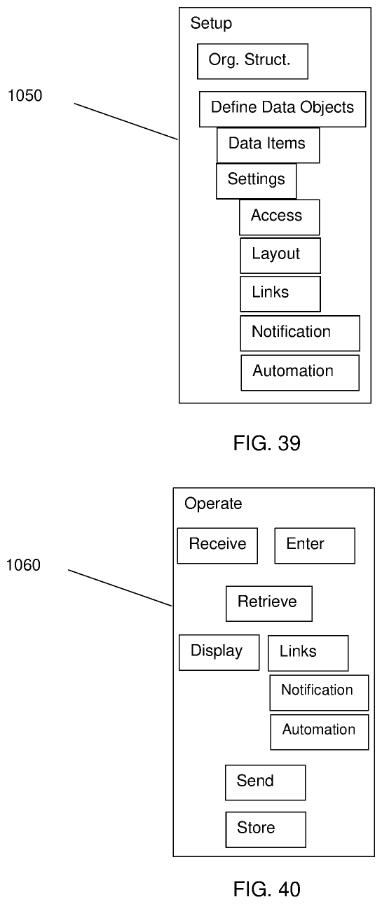

FIG. 39 provides an example of functional blocks 1050 for implementing instructions for implementing aspects of the system of FIG. 36 and in particular a builder 902 and customiser 904 described in relation to FIG. 23. Setup of the system comprises at least defining data objects such as 110, 406, 806, 816, and/or 906, such as described above in relation to FIGS. 2, 6, 15 and 23. Preferably it also comprises defining one or more organisation structures and users position in that structure, such as described above in relation to FIGS. 6A, 8 and 19-22. Defining data objects comprises defining data items 104, 304, 408, 808 and/or 908 in each object and associated widgets 118, such as described above in relation to FIGS. 2, 6, 15 and 23. Defining data objects also comprises using for example associator 802 described in relation to FIG. 15 to associate settings with each data item and/or each data object. The settings include access permission settings 112, 162, 303, 404 and or 810, such as described above in relation to FIGS. 2, 6, 15 and 23, and a layout 116 of the data object when it is displayed, such as described in relation to FIG. 3. Additional setting may be defined such as: links to other data items in other data objects such as described in relation to FIGS. 10 to 14; notifications such as described in relation to FIGS. 17, 23 and 25; and automation such as described in relation to FIGS. 18, 23 and 27. The ordinary skilled person will be able to determine the computer code to implement these functional requirements as described herein by translation of the functional requirements into a suitable computer language. The importance being in what the functional requirements are and how they operate.

FIG. 40 provides an example of functional blocks 1060 for implementing instructions for implementing aspects of the system of FIG. 36 and in particular a provider 804 and/or updater described in relation to FIG. 15 following setup of the system. In an embodiment the provider 804 receives an input, such as entered by a user or from another element of the system (for example from another group of the organisation or from another organisation, including for example receiving a link to a card). This causes selective retrieval of a data object and the data items therein according to the settings for that data object, such as described above in relation to FIGS. 1, and 9 to 15. The retrieved data object and its data items are displayed to the user according to the defined layout of the data object, preferably in the form of a card, as described herein. Data items in the data object that are linked to other data objects may have the displayed data updated when the data source is updated according to the access settings of the source. Data items may be updated by the user according to the access settings of the data object. When there are notifications and automation configured for the data object these may be performed according to the setup of those automations and notifications and/or the data item they are associated with. This may involve sending a data item to another data object, such as, as is described herein. The display of the card may be in a stack 830 and 832 of cards such as described in relation to FIG. 16. Changes to the data object may be stored, with the most recent being at the top of the stack and historic instances of the card saved in the store and able to be viewed in the stack, such as is described herein. The ordinary skilled person will be able to determine the computer code to implement these functional requirements as described herein by translation of the functional requirements into a suitable computer language. The importance being in what the functional requirements are and how they operate.

Advantageously a number of preferred embodiments have been described which may assist in organisation and sharing of information in a new/more efficient manner by providing information management systems that provide:
1. Data objects that can be displayed and which are associated with a number of data items comprising widgets where systems and methods of the embodiments allow access settings to be applied to the widgets independently.
2. Data objects that can be displayed and which are associated with a number of data items comprising widgets where systems and methods of the embodiments allow the data objects to be shared between entities within an organisation (inter-organisation) and between and organisation and one or more external organisations (intra-organisation).
3. Data objects that can be displayed and which are associated with a number of data items comprising widgets where systems and methods of the embodiments allow: (i) the data objects to be shared inter-organisation and intra-organisation; (ii) for access settings to be applied to the widgets on an independent level; and (iii) for different access settings being able to be selected inter-organisation and intra-organisation using automatic selectors.
4. Data objects that can be displayed and which are associated with a number of data items comprising widgets where systems and methods of the embodiments allow: (i) the data objects to be shared inter-organisation and intra-organisation; (ii) for access settings to be applied to the widgets on an independent level; and (iii) for different updating approaches to be applied inter-organisation and intra-organisation using automatic selectors.
5. Data objects that can be displayed and which are associated with a number of data items comprising widgets where systems and methods of the embodiments allow: (i) the data objects to be shared inter-organisation and intra-organisation; (ii) for access settings to be applied to the widgets on an independent level; and (iii) for each organisation to gain some independent control in connection with data items whilst still providing for updating intra-organisation.
6. Accessing setting and selector approaches allowing entities to share data items associated with a data objects based on their position within a group structure with options being provided including self+ancestor groups; self+sibling+ancestor groups; self+sibling groups; ancestor groups.

Modifications may be made to the present invention within the context of that described and shown in the drawings. Such modifications are intended to form part of the invention described in this specification.

1. An information management method comprising:
selectively retrieving data items, in connection with data objects each associated with one or more data items; wherein said selectively retrieving comprises selectively retrieving data items, associated with a selected data object, based on access settings associated with different groups of the data items associated with the data object, when the data object is associated with more than one group of data items.

2. An information management system comprising:
a provider for selectively retrieving data items, in connection with data objects each associated with one or more data items; wherein the provider is configured to selectively retrieve data items, associated with a selected data object, based on access settings associated with different groups of the data items associated with the data object, when the data object is associated with more than one group of data items.

3. An information management method comprising:
associating access settings with data items, in connection with data objects each associated with one or more data items; wherein associating access settings comprises associating access settings with different groups of the data items, associated with a selected data object, in a manner permitting each of the groups of the data items to be associated with a different access setting, when the data object is associated with more than one group of data items.

4. An information management system comprising:
an associator for associating access settings, in connection with data objects each associated with one or more data items; wherein the associator is configured to associate access settings with different groups of the data items, associated with a selected data object, in a manner permitting each of the groups of the data items to be associated with a different access setting, when the data object is associated with more than one group of data items.

5. An information management method according to claim 1 further comprising:
providing data items in connection with data objects each associated with one or more data items; said providing comprising providing linked data items; and updating the linked data items in response to linked data item access requests.

6. (canceled)

7. An information management method comprising:
storing groups of identities of users and group relationships, the group relationships defining associations between the groups to define an organisational structure; and
providing a selector configured to allow a user within at least one group of the organisational structure to select another group relative to a group within which the user is positioned, wherein the at least one group comprises a single group and the selector is configured to allow a user to select another group relative to the group within which the user is positioned.

8. (canceled)

9. (canceled)

10. (canceled)

11. An information management method comprising:
creating data objects having data items, the data items of each data object for visual display;
customizing access settings to be specified for different groups of data items.

12. (canceled)

13. An information management method according to claim 11 further comprising:
associating different access settings with different groups of data items associated with a selected data object, when the data object is associated with more than one group of data items.

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. An information management method according to claim 1, wherein the data items include trigger data items, each configured to execute an action in response to an update of a data item, associated with a data object that is associated with the trigger data item.

27. A method according to claim 26, wherein the trigger data items include trigger data items configured to execute actions sharing data objects with different organisations.

28. A method according to claim 26, wherein an update is the trigger.

29. A method according to claim 26, wherein the updated data item is compared to a trigger condition, which when met results in the triggering of the execution of the action.

30. A method according to claim 26, wherein the action is a notification action.

31. A method according to claim 26, wherein a trigger data item is configured to execute a share access action.

32. An information management method according to claim 1, wherein the access settings associated with different groups of data items associated with the data object comprise access settings internal to an organisation and access settings external to the organisation.

33. An information management method according to claim 1, wherein the access settings associated with different groups of data items associated with the data object comprise access settings for each organisation that has access to the data objects.

34. An information management method according to claim 1, wherein the access settings for each data item are associated with different groups of the data items in a manner that permits each of the groups of the data items to be associated with a different access setting.

35. An information management method according to claim 34, wherein the access settings associated with different groups of data items associated with the data object comprise access settings internal to an organisation and access settings external to the organisation.

36. An information management method according to claim 34, wherein the access settings associated with different groups of data items associated with the data object comprise access settings for each organisation that has access to the data objects.

37. An information management method according to claim 34, wherein the access settings associated with each group are selected according to the user's position within an organisational structure of an organisation to which the user belongs.

38. An information management method according to claim 34, wherein the retrieved data items are displayed in a grouping of the data items according to the access settings of the groups of data items.

39. An information management method according to claim 38, wherein the access settings associated with different groups of data items associated with the data object comprise access settings internal to an organisation and access settings external to the organisation.

40. An information management method according to claim 38, wherein the access settings associated with different groups of data items associated with the data object comprise access settings for each organisation that has access to the data objects.

41. An information management method according to claim 38, wherein the access settings determine which data items are displayed to a respective user.

42. An information management method according to claim 5 further comprising:
receiving a delinking command for a data object, duplicating the data object and the respective linked data items to form a duplicate data item for each linked data item, the duplicate data object being owned by an organisation, delinking the linked data items according to access settings associated with respective different groups of data items, where each duplicated data item is provided with a new access setting according to an organisation policy of the organisation

43. An information management method according to claim 7, wherein the selection of the other group assigns access rights to a data object by members of the other group.

44. An information management method according to claim 7, wherein access levels of the users are defined by organisation structure settings based on each user's selected group.

45. An information management method according to claim 11, wherein the visual display of the data items in each data object are visually grouped together.
